(19) United States
(12) Patent Application Publication
(10) Pub. No.: US 2025/0374877 A1
(43) Pub. Date: Dec. 11, 2025

(54) PLANT INJECTION SYSTEMS INCLUDING ACTUATORS AND INJECTION TOOLS, AND USES THEREOF

(71) Applicant: INVAIO SCIENCES INTERNATIONAL GMBH, BASEL (CH)

(72) Inventors: Jessica Holly COHEN, Lake Zurich, IL (US); Thomas GERSTER, Zwingen (CH); Beat MÜLLER, Olsberg (CH); Michael Christian OEHL, Reinach (CH); Christiaan Joseph WALSH, Huercal Overa (ES); Urs WIDMER, Dornach (CH); Philip Hugh WRIGHT, Alegrete (PT)

(21) Appl. No.: 19/101,876

(22) PCT Filed: Aug. 9, 2023
(86) PCT No.: PCT/US2023/071944

§ 371 Date: Feb. 6, 2025

Related U.S. Application Data
(60) Provisional application No. 63/396,559, filed on Aug. 9, 2022.
(60) Provisional application No. 63/515,499, filed on Jul. 25, 2023.

(51) Int. Cl. A01G 29/00

(52) U.S. Cl. CPC A01G 29/00

(57) ABSTRACT

Provided herein are devices and methods for administering liquid formulations to plants. The injection systems provided include an injection tool operatively connect to a fluid delivery device via an actuator. The injection systems are configured to deliver liquid formulation including one or more active ingredients to the vascular system of the plant.

### CROSS-REFERENCE TO RELATED APPLICATIONS

This application claims priority to and benefit of U.S. Provisional Patent Application No. 63/396,559, filed Aug. 9, 2022; and U.S. Provisional Patent Application No. 63/515,499, filed Jul. 25, 2023, each of which is hereby incorporated herein by reference in its entirety.

### FIELD

The present disclosure relates generally to devices and methods for administering liquid formulations to plants, and more specifically to an injection system (including an actuator, an injection tool, and a fluid delivery device) for positioning and mounting the fluid delivery device onto a plant to distribute a liquid formulation including one or more active ingredients to the plant.

### BACKGROUND

Plant injection has been used for administration of active ingredients to plants. Conventional plant injection approaches can involve drilling a borehole in a tree trunk and stoppering the borehole with a peg. A needle is inserted through the peg to discharge liquid into the borehole. There exists a need in the art for alternative plant injection systems that are easy to install and manufacture on a commercially viable scale.

### BRIEF SUMMARY

In some aspects, provided herein is an actuator for connecting an injection tool and a fluid delivery device. Typically, the fluid delivery device comprises a canister that holds liquid formulation, wherein the top of the canister has a lip, and wherein the fluid delivery device further comprises a stem connected to the canister. In some embodiments, the actuator comprises: an activator, wherein the activator is configured to trigger or activate the stem of the fluid delivery device by pressing on it, and wherein the activator is configured to mount the injection tool; and a frame, wherein the frame comprises one or more spreaders that press on the lip of the fluid delivery device and pulls itself against the lip, wherein the frame has one or more predetermined breaking points configured to break when the activator is pushed down. In some variations, the activator has a positioning slot configured to receive the injection tool so as to facilitate a precise connection between the actuator and the injection tool. In some variations, the activator comprises at least one first locking mechanism, the frame comprises at least one second locking mechanism, and the at least one first and at least one second locking mechanisms interface after the activator is pushed down to maintain the activator is a pressed down position.

In other aspects, provided are injection tips configured to deliver a liquid formulation into a plant. In some embodiments, the injection tip comprises: a cutting edge at the distal end of the injection tip; an injection tip base at the proximal end of the injection tip; a main pillar that extends from the cutting edge to the injection tip base along a central longitudinal axis of the injection tip; at least two side walls that extend from each end of the cutting edge to the injection tip base, wherein the cutting edge, sidewalls, and injection tip base form a wedge type body profile extending along a longitudinal axis; opposite faces that extend from the injection tip base and meet at the cutting edge; at least two cavities, at least one on each side of the main pillar, wherein each cavity is configured as an aperture through the opposite faces; a channel that extends along the central longitudinal axis through the injection tip base and terminates in the column portion of the main pillar, wherein the width of the channel is broader than the column portion of the main pillar; an orifice that extends upwards along the channel from injection tip base through the column portion of the main pillar. In some variations, the channel is configured to receive the liquid formulation and empty the liquid formulation into the cavity via the orifice.

In certain embodiments of the foregoing, the main pillar comprises a shoulder portion proximate the cutting edge and a column portion proximate the injection tip base. In certain embodiments, each cavity comprises: a primary region, at least in part bound by the side wall and further bound by the shoulder portion of the main pillar, wherein the primary region has a maximum longitudinal height; and a secondary region, at least in part bound by the shoulder portion and the column portion of the main pillar, wherein the secondary region has a maximum longitudinal height less than the maximum longitudinal height of the primary region.

In other aspects, provided are injection tools configured to deliver a liquid formulation into a plant. In some embodiments, the injection tool comprises: any of the injection tips described herein connected to a socket, and the channel of the injection tip is configured to receive the liquid formulation and empty the liquid formulation into the cavity via the orifice. In some variations of the foregoing, the socket is a H-shaped or Y-shaped socket. In other variations, the injection tip is coupled to the socket via a sealing region, wherein the sealing region comprises a primary seal and optionally a secondary seal. In certain variations when the secondary seal is present, the secondary seal is disposed between the primary seal and the socket.

In yet other aspects, provided is a plant injection system, comprising: any of the actuators described herein; any of the injection tools as described herein; and a fluid delivery device. In some variations, the socket of the injection tool is configured to insert into the actuator so that the injection tool is in fluid connection with the fluid delivery device by connection through the actuator.

In yet other aspects, provided is a method for positioning and mounting any of the plant injection systems described herein onto a plant part. In some embodiments, the method comprises: installing the injection tool into the trunk or stem of the plant part; setting the injection tool by pressing on the top beam; and pushing the fluid delivery device so that the predetermined breaking points of the actuator bridges allowing the activator to snap into the frame of the actuator.

In yet other aspects, provided is a method of distributing a liquid formulation to a plant using any of the injection tools described herein, or any of the injection systems described herein. In some embodiments, the method comprises: penetrating the plant with the injection tool; and distributing the liquid formulation through the injection tool to the plant.

In certain aspects, provided is a method of modulating the phenotype of a plant or a multitude of plants, or treating a plant infected with a pathogen, or mitigating, controlling and/or eradicating a pathogen in a plant, or improving abiotic or biotic stress tolerance in a plant. In some embodiments, the method comprises: installing any of the plant injection systems described herein in the plant or multitude of plants, and applying a liquid formulation of an active ingredient to modulate the phenotype of the plant, or treat a plant infected with a pathogen, or mitigate, control and/or eradicate a pathogen in a plant, or improve abiotic or biotic stress tolerance in a plant.

### DESCRIPTION OF THE FIGURES

The present application can be understood by reference to the following description taken in conjunction with the accompanying figures.

FIG. 1 depicts an exemplary actuator.

FIG. 2A-2C are cross-sections of an exemplary actuator mounted to a fluid delivery device.

FIGS. 3A and 3B illustrate the constraints and loading, respectively, used for finite element analysis of an exemplary actuator.

FIG. 4 depicts the maximal displacement region from a finite element analysis of the exemplary actuator of FIGS. 3A and 3B.

FIGS. 5A-5C depict an exemplary process to install an injection tool and fluid delivery device connected by the exemplary actuators described herein onto the stem or trunk of a plant.

FIGS. 6A and 6B depict a cross-sectional view of an exemplary actuator as described herein.

FIGS. 7A-7C depict different views of an exemplary injection tool suitable for use with the actuators described herein.

FIGS. 7D-7F are cross sections of the injection tool of FIG. 7A-7C mounted to an exemplary actuator that is mounted to an exemplary fluid delivery device.

FIG. 7G depicts the mounting of an exemplary injection tool to an exemplary actuator.

FIGS. 8A and 8B depict an exemplary system of an injection tool positioned in an exemplary actuator connected to a canister with a bag-on-valve insert.

FIG. 9A depicts an exemplary injection tool inserted into the exemplary actuator.

FIG. 9B depicts an exemplary injection tool inserted into the exemplary actuator connected to with a canister with a bag-on-valve insert.

FIG. 10 depicts another exemplary system of an injection tool positioned in another exemplary actuator connected to a fluid delivery device.

FIGS. 11A and 11B depict cross-sections of exemplary injection tips.

FIGS. 12A-12J depict various views and perspectives of an exemplary injection tool.

FIGS. 13A-13C, as well as FIGS. 14A-14E depict other exemplary injection tools in various views and perspectives.

FIGS. 15A-15G depict various views of an exemplary actuator.

FIGS. 16A-16C depict various views of an exemplary injection tool connected to an exemplary actuator.

### DETAILED DESCRIPTION

The following description sets forth exemplary systems, methods, parameters and the like. It should be recognized, however, that such description is not intended as a limitation on the scope of the present disclosure but is instead provided as a description of exemplary embodiments.

In some aspects, provided herein is an actuator that can be mounted onto a fluid delivery device containing liquid formulation, without triggering the fluid delivery device. In some embodiments, such fluid delivery device comprises a canister, such as a canister with a bag-on-valve insert. The actuators described herein help facilitate an automated installation process of the injection tip and fluid delivery device to deliver the liquid formulation to the plant. In some embodiments, the actuator may be manufactured by injection molding.

### Actuator

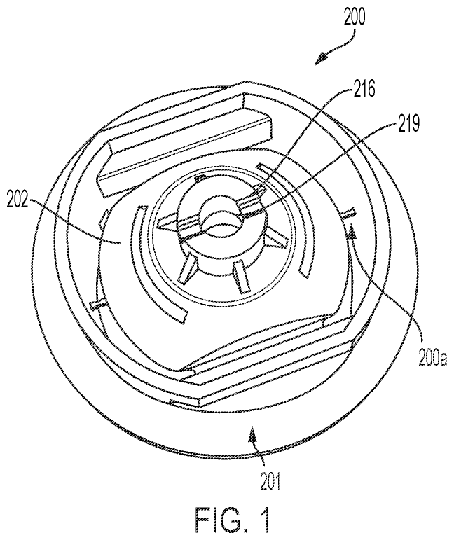

In some embodiments, the actuator comprises an activator and a frame. With reference to FIG. 1, exemplary actuator 200 is depicted. Activator 202 triggers or activates the stem of the fluid delivery device (e.g., a spraycan) by pressing on it. The activator is configured to mount the injection tool (e.g., an injection tip), which is equipped with positioning slots 219 on female port 216 to ensure a precise connection between these two parts. Frame 201, as depicted in FIG. 1, contains four spreaders that press on the crimped part of the fluid delivery device and hooks itself to the crimped part. Element 200a in FIG. 1 refers to one of two predetermined breaking points on the frame that will break when the activator is pushed down. This exemplary activator may be injection molded as one part.

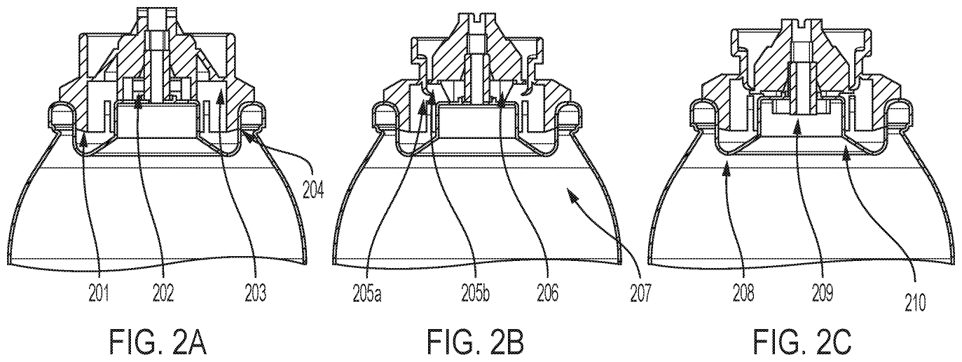

FIGS. 2A-2B are cross-sections of an example of the actuator of FIG. 1 mounted to a canister. FIG. 2A and 2B show the actuator in a non-activated configuration, with FIG. 2A being a cross-section corresponding to line A-A of FIG. 1 and FIG. 2B being a cross-section corresponding to line B-B of FIG. 1. FIG. 2C is a cross-section corresponding to line B-B of FIG. 1 with the actuator in an activated configuration.

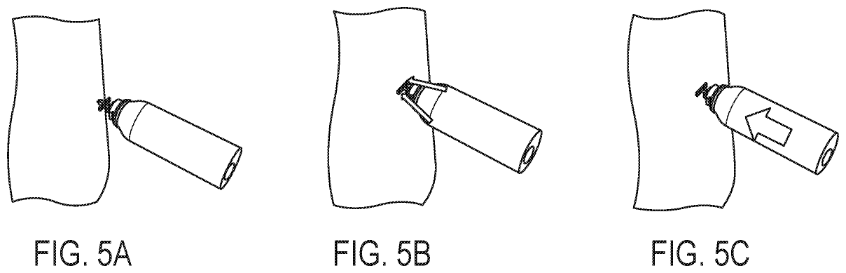

The actuator includes a frame 201 for mounting the actuator on a valve cap 208 of a fluid delivery device 207. The frame 201 can lock in place on the valve cap 208 via one or more spreaders 204 that include a hook-like shape that locks into undercuts in the valve cap 208, the undercuts being formed by the crimping process that connects the valve cap 208 with the can 207. The connection between the spreaders 204 and the valve cap 208 is ridged enough to withstand axial and angular forces up to predefined amounts such that the actuator is retained on the fluid delivery device 207 during normal usage. For example, the spreaders 204 can be configured to prevent the actuator from falling of the valve cap 208 when the assembly (the actuator mounted to the fluid delivery device) is hanging from an injection tip mounted to the actuator with the longitudinal axis of the assembly oriented perpendicularly to gravity (such as shown, for example, in FIGS. 5A-C). The actuator can include a secondary holder mechanism 206 that is pushed over the pedestal 210 of the valve cap 208 to further retain the actuator on the fluid delivery device 207 and absorb radial directed forces.

The actuator includes bridges 203 that connect the activator 202 to the frame 201. This connection may serve two purposes. First, it holds the non-activated activator 202 in place. Second, it requires a defined force in an axial direction of the fluid delivery device-to-actuator assembly in order to prevent accidental discharge of the contents of the fluid delivery device 207. The actuator includes a “total release” activator meaning once activated the total contents of the fluid delivery device 207 are released in one continuous flow. This is achieved via one or more locking mechanisms 205a of the activator 202 being pushed under and held in place respectively by the respective locking mechanism 205b of the frame 201, as shown in FIG. 2C. The locking mechanisms 205a/205b may be configured such that they are the weakest link of the whole assembly—meaning they are strong enough to keep the stem 209 of the fluid delivery device 207 pressed (in the in activated position), allowing the contents of the fluid delivery device 207 to exit the fluid delivery device, while being weak enough to break in the event of manipulation by an excessive force such that the activator 202 can separate from the frame 201, enabling the stem 209 to return to the unactivated position, which stops content flow, preventing any spillage.

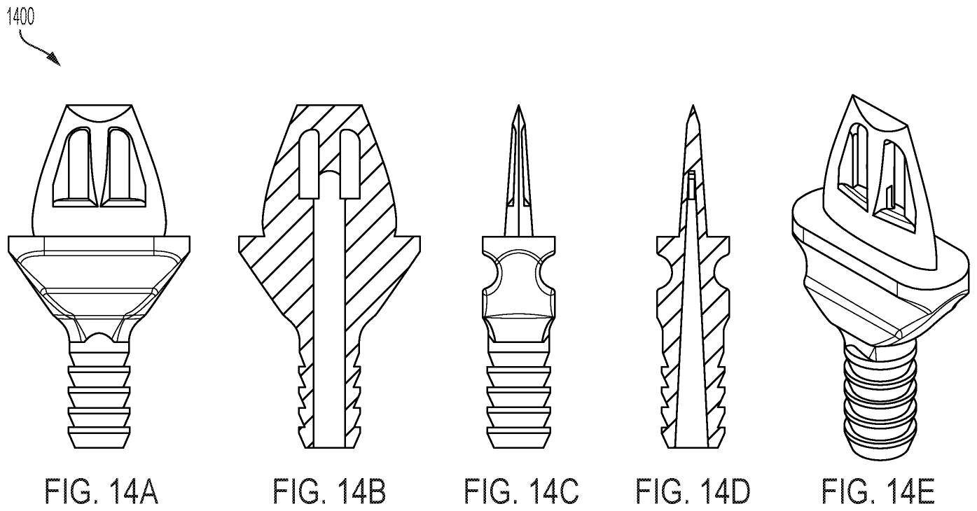

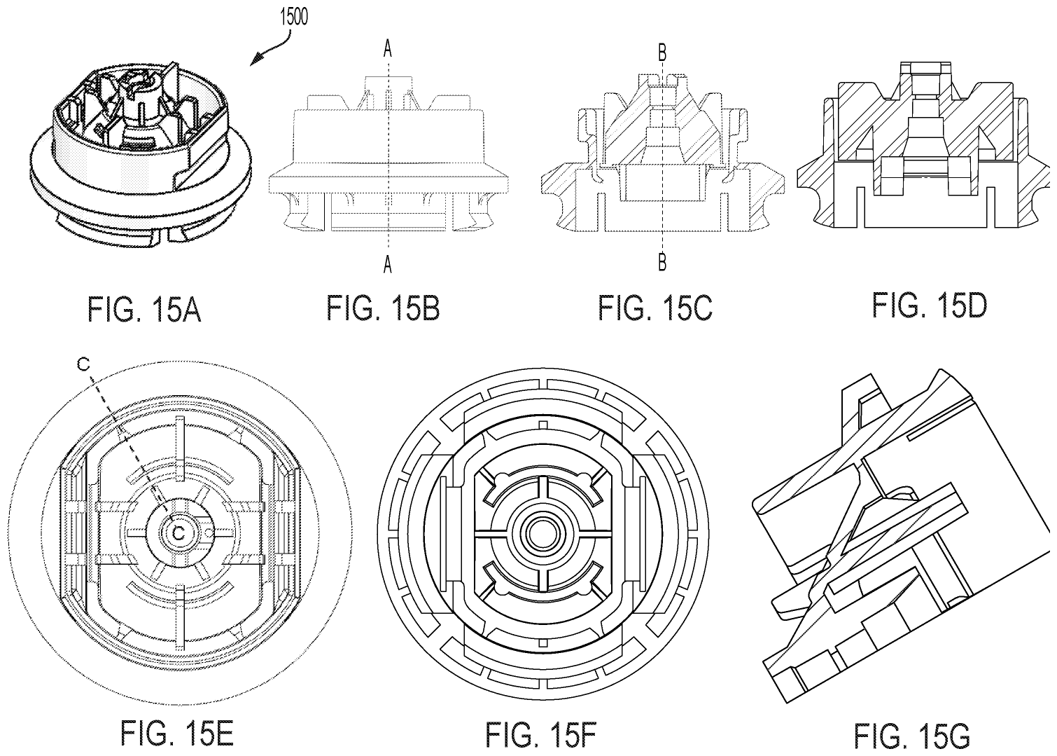

The actuators described herein may have one or more additional features, or modified features. For example, FIGS. 15A to 15G depict another exemplary actuator 1500. FIG. 15A depicts a perspective view. FIG. 15B depicts front view. FIG. 15C depicts cross-sectional view along dashed line A-A of FIG. 15B. FIG. 15D depicts cross-sectional view along dashed line B-B of FIG. 15C. FIG. 15E depicts top view. FIG. 15F depicts bottom view. FIG. 15G depicts cross-sectional view along dashed line C-C of FIG. 15E.

With reference to FIGS. 15A to 15G, one modification includes, for example, changing the rib height for actuation visibility. For example, an increase in height of the 6 ribs located on the actuator moving part allows, for instance, for visual confirmation of actuator activation. In other words, this modification allows the ribs to be seen above the outer actuator body, indicating that the actuator is not activated. If the ribs cannot be seen above the outer actuator body, the actuator is activated.

Another modification may include, for example, increasing rib height and length around the dome. For instance, the modifications may include an increase in length of the 4× bottom ribs and an increase of the length of the dome cup to 2×120 degrees of the actuator moving part. This may provide additional material contact of the actuator moving part and the dome of the canister when activated, which may help to reduce the tilting effect of the canister from horizontal-when fully assembled, filled and inserted into the tree.

Another modification may include, for example, the addition of ribs to limit even more the tilt effect. For example, 4× ribs may be added to the internal walls of the outer actuator body. The additional 4 ribs may be located adjacent to the 4× side ribs of the actuator moving part, to provide additional support to the actuator when activated to reduce the tilting effect of the canister from horizontal—when fully assembled, filled and inserted into the tree.

### Performance Criteria

In some variations, when assembled, the injection tool (e.g., injection tip) sits in the actuator and is secured within the internal locating slots of the actuator. In certain variations, removal of the injection tool from the actuator will require a suitable force. In certain variations, a suitable rotational torque is required to rotate the injection tool in the actuator.

In some variations, the manufacture of the actuator allows for assembly of the injection tool and actuator in a way that does not cause damage to either part.

In some variations, the injection tool and actuator withstand the forces originating from the horizontal installation of the full assembled fluid delivery device, such as a 100 ml canister, with a suitable weight, without occurrence of mechanical failure or fatigue.

In some variations, the actuator/canister assembly (at the point of contact) withstand the forces originating from the horizontal installation of the full assembled canister, with a suitable weight, without occurrence of mechanical failure or fatique.

In some variations, the point of contact between the actuator/fluid delivery device assembly requires a suitable rotational torque to rotate the actuator within the collar of the canister of the fluid delivery device.

In some variations, when assembled, the injection tool is horizontal when fitted into the actuator.

In some variations, from a fixed point of the injection tool, the actuator/fluid delivery device assembly withstands a certain force from all axis before the connection of the actuator and fluid delivery device fails. Should the actuator/fluid delivery device assembly fail, the fluid delivery device immediately de-activates.

In some variations, to ensure the deactivation of the fluid delivery device due to mechanical damage, the failure load of the stem actuation point is less than all other assembly points/possible points of failure within injection tool/actuator/fluid delivery device.

In other variations, the injection tool/actuator connection seals properly and maintains the seal against the back pressure origination from the slow release of liquid formulation with a maximum starting pressure of at least 1 bar, at least 2 bar, at least 3 bar, at least 4 bar, or at least 5 bar for the duration of the injection.

In other variations, the actuator/stem connection seals properly and maintains the seal against the back pressure origination from the slow release of liquid formulation with a maximum starting pressure of at least 1 bar, at least 2 bar, at least 3 bar, at least 4 bar, or at least 5 bar for the duration of the injection.

In yet other variations, the force required to activate the stem and allow for continuous activation is within a suitable force.

In yet other variations, once the fluid delivery device is activated, the activation is maintained during the whole duration of application of the liquid formulation until the fluid delivery device is empty.

### Commercial Advantages

The actuator described herein presents several commercial advantages. For example, the actuator is designed for an automated installation. The actuator provides a stiff connection to the injection tool (e.g., injection tip), which facilitates guiding the injection tool with the whole assembly. The injection tool along with the fluid delivery device can be pre-installed onto a plant without triggering the fluid delivery device to release its contents.

The actuator is also designed to provide a suitable clamping force to securely clamp the fluid delivery device onto the plant. In some variations, the actuator comprises four spreaders that cannot be easily loosened with levers.

The actuator does not require the use of any tubing to connect the injection tool (e.g., injection tip) to the fluid delivery device, as the actuator provides a stiff connection between the injection tool and fluid delivery device.

The actuators as described herein may be installed according to the exemplary process depicted in FIGS. 5A-5C. In FIG. 5A, the injection tool (e.g., injection tip) is first installed into the trunk or stem of the plant. The tip is positioned such that there is enough space for the fluid delivery device (e.g., the spraycan) and there are no branches in the way. In FIG. 5B, the injection tool is then set by pressing on the top beam. Then, in FIG. 5C, the fluid delivery device is pushed. The predetermined breaking points of the actuator bridges allowing the activator to snap into the frame.

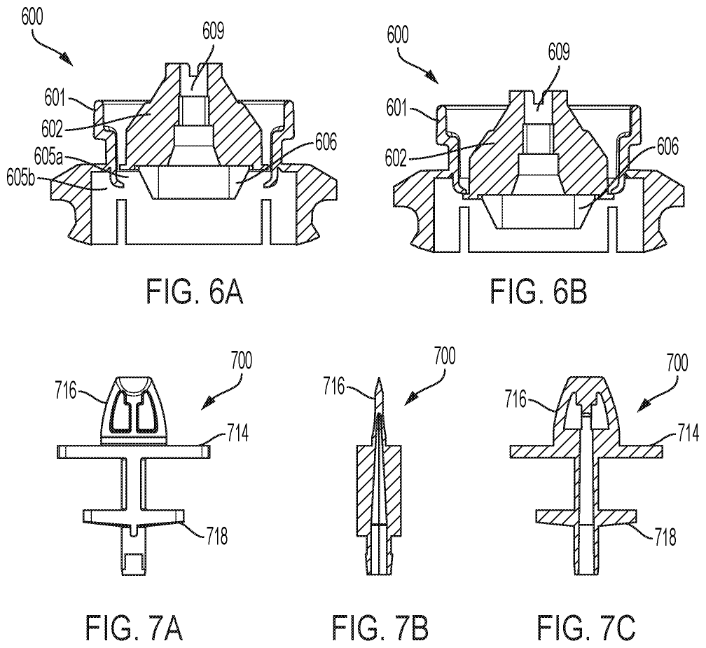

A cross-section of exemplary actuator 600 is described in FIGS. 6A and 6B. Actuator 600 includes frame 601 for mounting actuator 600 on a fluid delivery device (not shown). Actuator 600 includes a “total release” activator meaning once activated the total contents of fluid delivery device are released in one continuous flow. This is achieved via one or more locking mechanisms 605a of activator 602 being pushed under and held in place respectively by respective locking mechanism 605b of frame 601. Locking mechanisms 605a/605b may be configured such that they are the weakest link of the whole assembly-meaning they are strong enough to keep stem 609 of fluid delivery device pressed (in the in activated position), allowing the contents of fluid delivery device to exit the fluid delivery device, while being weak enough to break in the event of manipulation by an excessive force such that activator 602 can separate from frame 601, enabling stem 609 to return to the unactivated position, which stops content flow, preventing any spillage. Actuator 600 may include a base portion 606, which can abut a valve cap of a canister (e.g., valve cap 208 of a fluid delivery device 207 of FIGS. 2A-C).

### Injection Tools

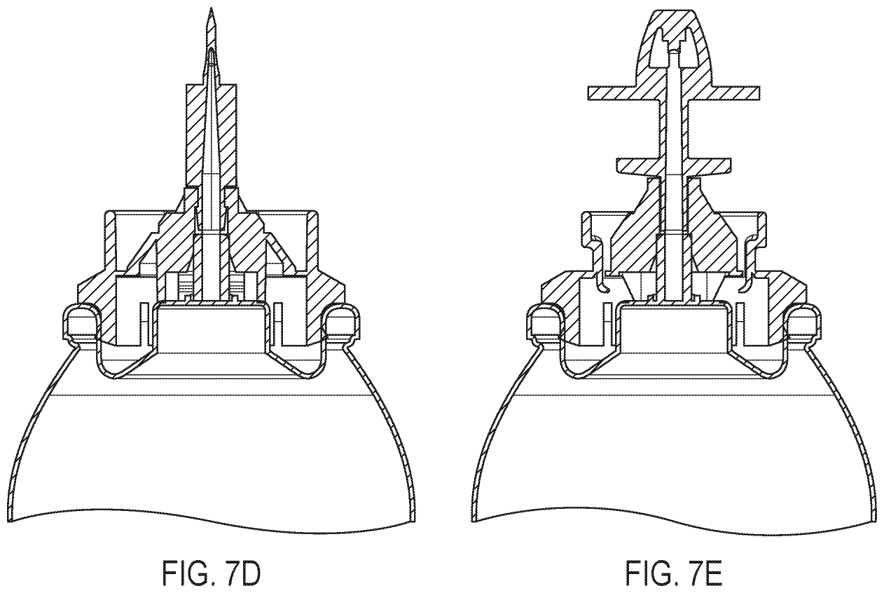

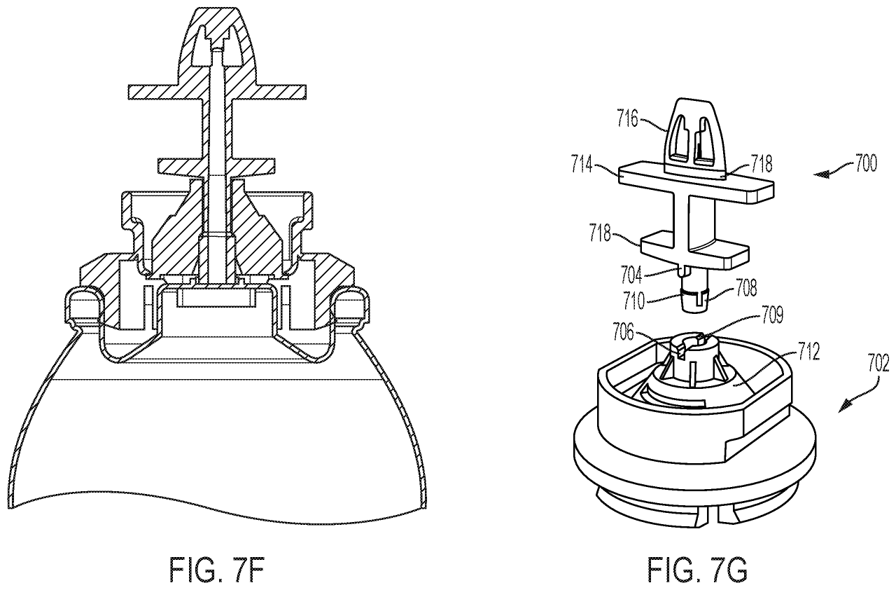

Any injection tools compatible with the actuator and the fluid delivery devices described herein may be used. FIGS. 7A-7C depict an exemplary injection tool, suitable for use with the actuators and fluid delivery devices described herein.

In some aspects, provided are injection tools that include an injection tip, at least a portion of which is designed to be lodged into a plant, for example, the stem or trunk of a plant. The injection tip has a channel system (having one or more channels) through which fluid can flow, and the channel system delivers the fluid into cavities of the injection tool. In some embodiments, the fluid may enter into the cavities through an orifice that extends upwards along the channel from the base of the injection tip through the middle of the injection tip, as depicted in FIG. 7C. In other embodiments, the fluid may enter into the cavities through the orifices or distribution ports. In some variations, any suitable injection tips and injection tools may be configured for use with the actuators described herein, including those described in WO 2020/021041 and WO 2021/152093.

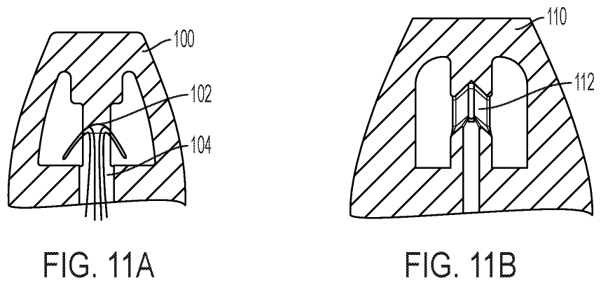

FIGS. 7A-7C depict one exemplary design of the injection tip and tool. With reference to FIG. 11A, depicted is a cross-section of exemplary injection tip 100, which has a similar design as compared to the exemplary injection tip depicted in FIGS. 7A-7C. Channel 104 extends along a central longitudinal axis through the injection tip base and terminates in the column portion of main pillar at top 102, which as depicted has a curvature that causes liquid traveling through channel 104 to exit through orifices into the cavities at an angled, backward direction as compared to the direction in which the liquid traves through the channel. This can help minimize or prevent clogging of the injection tool. Injection tool 100 may be made via injection molding or additive manufacturing.

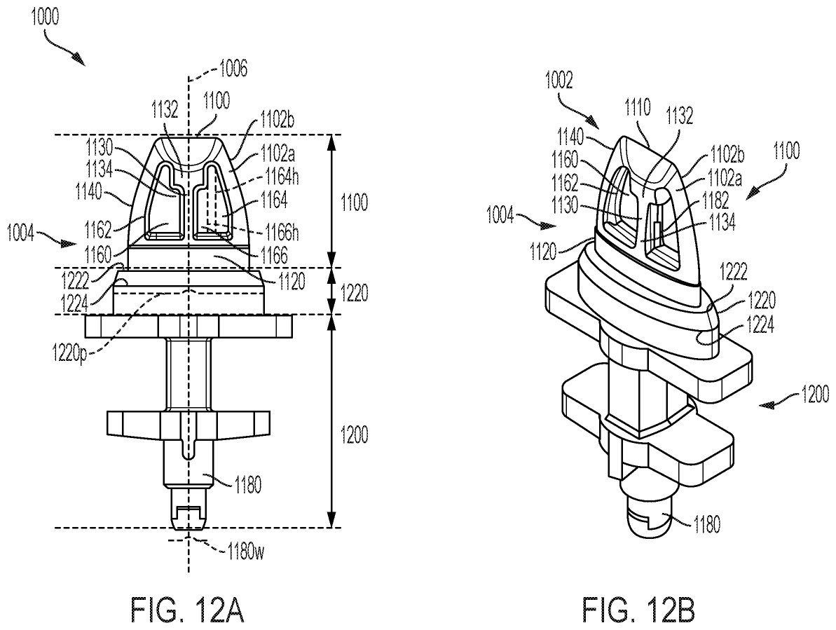

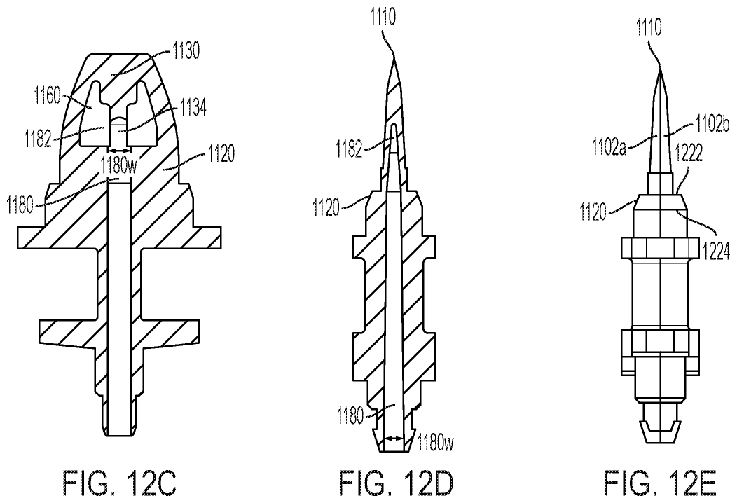

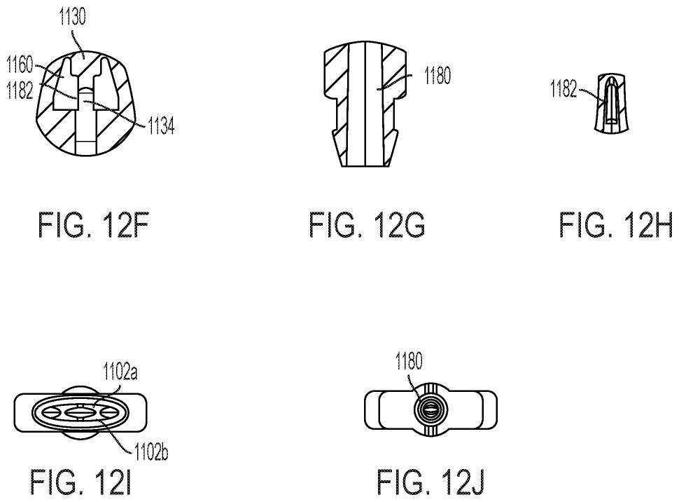

With reference to FIGS. 12A and 12B, the front and perspective views, respectively, of exemplary injection tool 1200 are depicted, and the components and features of the injection tool are described in more detail. Injection tool 1000 includes injection tip 1100 connected to socket 1200 through sealing region 1220. Injection tip 1100 includes cutting edge 1110 at distal end 1002 of the injection tip, and injection tip base 1120 at proximal end 1004 of the injection tip.

Injection tip 1100 also includes main pillar 1130 that extends from cutting edge 1110 to injection tip base 1120 along central longitudinal axis 1006 of the injection tip. Injection tip 1100 further includes two side walls 1140 that extend from each end of cutting edge 1110 to injection tip base 1120. Main pillar 1130 has shoulder portion 1132 proximate cutting edge 1110 and column portion 1134 proximate injection tip base 1120.

Each cavity 1160 has primary region 1164, at least in part bound by side wall 1140 and further bound by shoulder portion 1132 of main pillar 1130. Primary region 1164 has maximum longitudinal height 1164h. Each cavity 1160 has secondary region 1166, at least in part bound by shoulder portion 1132 and column portion 1134 of main pillar 1130. Secondary region 1166 has maximum longitudinal height 1166h less than maximum longitudinal height 1164h of primary region 1164.

Cutting edge 1110, sidewalls 1140, and injection tip base 1120 form a wedge type body profile extending along a longitudinal axis. Injection tip 1100 has opposite faces 1102a and 1102b that extend from injection tip base 1120 and meet at cutting edge 1110. Injection tip 1100 has two cavities 1160, one on each side of main pillar 1130. Each cavity 1160 is configured as an aperture through opposite faces 1102a and 1102b. Injection tip 1100 also has channel 1180 that extends along central longitudinal axis 1006 through injection tip base 1120 and terminates in the column portion of main pillar 1130.

With reference to FIG. 12C, which provides a cross-sectional view of the injection tip, width 1180w of channel 1180 is broader than the width of column portion 1134 of main pillar 1130. With reference to FIGS. 12A-12C, injection tip 1100 also has orifice 1182 that extends upwards along channel 1180 from injection tip base 1120 through column portion 1134 of main pillar 1130. Channel 1180 is configured to receive the liquid formulation and empty the liquid formulation into cavities 1160 via orifices 1182.

FIGS. 12D-12J depict other exemplary views of the injection tool. It should be understood that variations of the exemplary injection tip depicted in FIGS. 11A and 12A-12J may be used.

For example, with reference to FIG. 11B, another exemplary injection tip 110 is depicted. In this cross-sectional view, injection tool 110 includes distribution channels 112 that are positioned at an angle, backward orientation as compared to the direction in which the liquid travels through the channel that can minimize or prevent clogging. Due to the relatively more complex geometry and orientation of the channels 112, injection tool 110 may require additive manufacturing.

In another example, with reference to FIGS. 14A-14E, another exemplary injection tool 1400 is depicted. Injection tool 1400 has an injection tip with a different cavity shape as compared to the injection tip depicted in FIGS. 12A and 12B, as discussed above. In particular, the injection tip of FIGS. 14A, 14B and 14E do not have two different regions within a given cavity (referring to the primary and secondary regions of a cavity, in which the regions have different longitudinal heights) as depicted in FIGS. 12A and 12B. The injection tip of FIGS. 14A-14E, as depicted, shares other similar features (e.g., with respect to the cutting edge, the injection tip base, the main pillar and side walls, as well as the positioning of the cavities within the injection tip and the wedge type body profile of the injection tip) as the injection tip described above in FIGS. 12A and 12B. Injection tool 1400 has a Y-shaped socket, which is a different socket shape/type as compared to the injection tool in FIGS. 12A and 12B. Variations of the socket design are discussed in further detail below.

In some embodiments, the injection tips described herein, including the exemplary injection tips described in FIGS. 12A and 12B as compared to FIGS. 14A-14E have an average flow rate to deliver liquid formulation into the plant (e.g., tree) greater than about 50 ml/min. However, it should be understood that the design of the injection tip, including the shape and design of the cavities and/or the channels and ports/orifice that deliver the liquid formulation into the cavities, can have an impact on the average flow rate of the liquid formulation into the plant (e.g., tree).

For example, with reference again to FIGS. 12A and 12B as compared to FIGS. 14A-14E, the shape of the cavities in the injection tips may be one factor that impacts the average flow rate at which liquid formulation is delivered to the plant using the injection tips. In some variations, injection tips with the channel/orifice design set forth in FIGS. 12A and 12B and FIGS. 14A-14E were surprisingly observed to an average flow rate of greater than about 50 ml/min, greater than about 100 ml/min, greater than about 150 ml/min, greater than about 200 ml/min, or greater than about 225 ml/min; or between about 50 ml/min and 300 ml/min, between 100 ml/min and 250 ml/min, or between 200 ml/min and 250 ml/min.

Further, injection tips with the cavity shape set forth in FIGS. 12A and 12B was surprisingly observed to have a higher average flow rate than injection tips with the cavity shape set forth in FIGS. 14A-14E. In some variations, injection tips with the cavity shape set forth in FIGS. 12A and 12B were surprisingly observed to have an average flow rate of greater than about 235 ml/min, or greater than about 250 ml/min; or between about 235 ml/min and 240 ml/min.

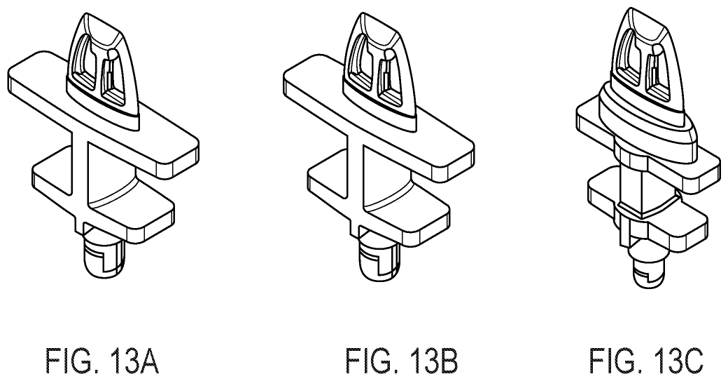

It should be understood that the size and shape of various components/features of the injection tip may vary, depending on the type, size, maturity of the plant for which the injection tips are designed for use with. With reference to FIGS. 13A-13C, three different exemplary injection tools with H-shaped sockets are depicted. The three different injection tools have different size injection tips, e.g., with respect to the length along the longitudinal axis and/or the width perpendicular to the longitudinal axis, as well as with respect to the width and size of the injection tip base relative to the socket. The injection tool depicted in FIG. 13C also has a different sealing region/component that connects the injection tip base with the socket, as compared to the injection tools depicted in FIGS. 13A and 13B.

In the exemplary injection tools depicted in FIGS. 12A-12J, as well as FIGS. 13A-13C, the injection tips are connected to a socket having a H-shape. This H-shaped socket may be configured to insert into any of the actuators described herein so that the injection tool is in fluid connection with the fluid delivery device by connection through the actuator.

For example, FIGS. 7D-7F are cross sections of the injection tool of FIG. 7A-7C mounted to an actuator that is mounted to a fluid delivery device. FIGS. 7D and 7E are orthogonal cross-sections showing the assembly in a non-activated configuration and FIG. 7F is a cross-section through the same plane as FIG. 7E showing the assembly in the activated configuration.

FIG. 7G illustrates the mounting of the injection tool to an exemplary actuator 702. The injection tool 700 includes one or more positioning features 704 that may mate with corresponding positioning features 706 of the actuator 702 to align the injection tool 700 to the actuator 702. The male port 708 of the of the injection tool 700 can include one or more rims 710 that allow male port 708 to be pushed into female port 709 of activator 712 of actuator 702 and retained in female port 709 of the activator 712 by snapping behind corresponding undercuts within female port 709 (see, e.g., FIGS. 7D-7F). Male port 708 and female port 709 can be sized to have small or no clearance (e.g., a press fit) when mated, such as to maintain a seal. Alternatively, clearance may be provided and the mating between the one or more rims 710 and the associated undercuts may provide the sealing when forced together under pressure of the fluid outflow during activation.

The socket of injection tool 700 is shaped like a sideway H (also referred to herein as “H-shape”) for easier placing. Top beam 714 of the H-shaped socket provides a large contact surface for the tree to minimize or avoid damage to the tree, and this top beam can also be used to transmit the force to injection tip 716. Bottom beam 718 of the H-shaped socket can be smaller, and is designed to pull the injection tip out of the tree, which needs less force than pushing the tip into the tree. Injection tool 700 may be manufactured by additive manufacturing or injection molding.

Bottom beam 718 of the H-shaped socket of injection tip 716 may be configured to provide a thickened sealing surface designed to spread the wood and create an equal pressure around the tip of injection tool 700 when inserted into a tree, thus providing a seal. This can improve the reliability and stability of the injection tip 716.

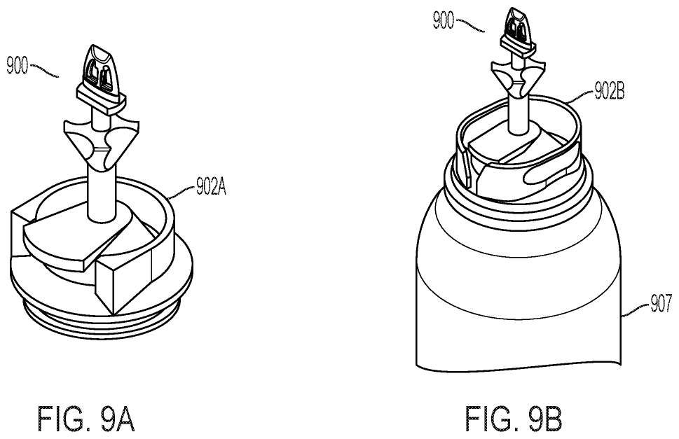

FIG. 9A depicts another exemplary injection tool/actuator assembly.

In some variations, other shapes for the socket for the injection tools are contemplated. For example, with reference again to FIGS. 14A-14E, a Y-shaped socket is depicted, with a single port configured to receive liquid formulation from the fluid delivery device.

In some embodiments, the injection tools described herein are installed in plants having relatively small and large sizes or diameters (e.g., trunk or stem diameters). In one example, the portions of the injection tools installed in plants have dimensions of around 5 mm or less (e.g., width) and 1 mm or less (e.g., height) and accordingly the tools are configured for installation in plants with stems, trunks, roots, limbs or the like of 5 mm or more in size, such as diameter.

In some embodiments, the lodged portion of the injection tool is sized and shaped to minimize damage to the target plant when inserted into the plant, while maintaining efficient functionality of the injection tool in delivering the desired dosing of liquid formulation over the desired time period directly to the active vasculature of the plant. In some variations, penetrating portion of the injection tip and injection tip base are cooperatively sized and shaped to work together to minimize damage to the target plant while maintaining efficient functionality of the tip. For example, the length of injection tip may be chosen to be less than the depth of the sapwood in the trunk of the tree and tool base is configured with a flange abutting the bottom end of the injection tip. In some variations, the flange is sized and shaped to mitigate the risk of inserting the injection tool beyond the end of injection tip abutting flange and therefore beyond the inner circumference of the sapwood and into the heartwood. In some variations, flange has a width that is wider than the widest part of the injection tip. In one example, the multiport injection tip includes one or more dimensions configured to minimize trauma to the plant caused during installation. The minimal profile of the tip (as well as other tip embodiments described herein) minimizes trauma to a plant in comparison to larger profile devices including syringes, plug, pegs or the like having dimensions of around 7 mm (7.14 mm in one example) a full 2 mm larger than the example tip. Accordingly, the potential for tree damage is reduced and the potential for fungal, bacterial, and insect ingress is minimized (e.g., reduced or eliminated). In one example, the tip as well as the other tip examples described herein are readily used with plants having stems, trunks, limbs or the like having diameters larger than 4.68 mm including, but not limited to, fruit trees, nut trees, berry shrubs, flowering plants as well as arbor and forest trees.

In certain embodiments, the injection tools selected allow for precision delivery (also referred to as “precision injection”) of a formulation into the plant. Precision delivery refers to delivering the formulation only or substantially only into a target location in the plant. For example, in some embodiments, the target location is the active vasculature of the tree. In some variations, the active vasculature of a tree is the xylem and/or the phloem. In other embodiments, precisely delivering the liquid formulation comprises inserting the injection tool such that the distribution reservoir is positioned in and no further than the active vasculature of the plant.

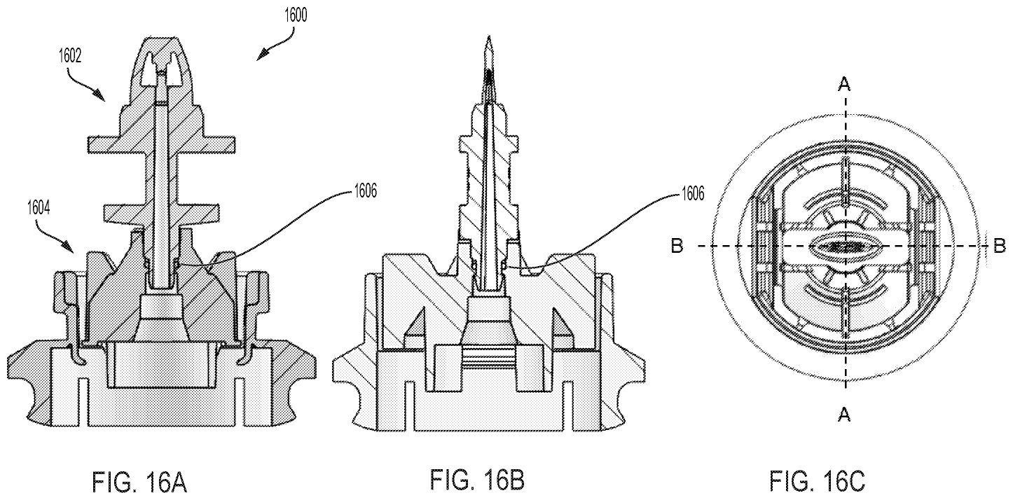

In some embodiments, the actuator may further comprise a sealing component, such as an o-ring, at the interface between the actuator and the socket of an injection tool. For example, the actuators described herein may be modified around the tip socket of the actuator moving part to create an initial increased diameter cavity for the injection tool stem location with a remaining cavity underneath the increased injection tool stem diameter for optional placement of a sealing component, such as an o-ring, to provide additional resistance against potential leakage during the tree injection process. FIGS. 16A to 16C depict exemplary injection tool 1602 connected to exemplary actuator 1604, where actuator 1604 comprises o-ring 1606 in contact with injection tool 1602. FIG. 16A depicts cross-sectional view along dashed line B-B of FIG. 16C. FIG. 16B depicts cross-sectional view along dashed line A-A of FIG. 16C. FIG. 16C depicts top view.

### Fluid Delivery Device

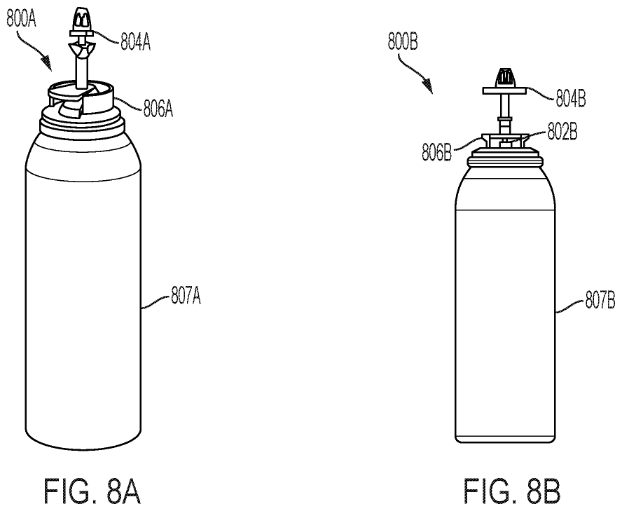

Any suitable fluid delivery devices may be used with the actuators and injection tools described herein, and in the injection systems described herein. In some embodiments, the fluid delivery device comprises a canister. FIG. 8A depicts exemplary system 800A comprising injection tool 804A, actuator 806A, and canister 807A. FIG. 9A depicts injection tool 900 connected to actuator 902A.

In some embodiments, the canister has a bag-on-valve insert. For instance, with reference to FIG. 8B, the bag-on-valve insert is connected to a stem that receives the socket of the injection tool. FIG. 8B depicts exemplary system 800B comprising injection tool 804B, actuator 806B, and canister 807B. Bag-on-valve insert (not labeled) is connected to stem 802B of the bag-on-valve insert. FIG. 9B depicts injection tool 900 connected to actuator 902B, along with bag-on valve insert (not labeled, inside canister) and delivery device 907.

In one variation, the fluid delivery device is a spraycan.

In some embodiments, the fluid delivery device contains any suitable liquid formulations and active ingredients, including as described below.

### Injection Systems

In some aspects, provided herein are injection systems comprising: an injection tool, an actuator, and a fluid delivery device. In some variations, the injection tool is connected to the actuator through the socket of the injection tool that extends from the base of the tool body, and is configured to connect with the stem of the fluid delivery device. The injection tool is in fluid connection with the fluid delivery device by connection through the actuator. The term “in fluid connection” relates to a connection enabling a transfer of fluid, particularly from the fluid delivery device to the injection tool.

FIGS. 8A, 8B and 9B depict exemplary injection systems, in which an injection tool is connected to the actuator through the stem, and the actuator is installed onto a fluid delivery device.

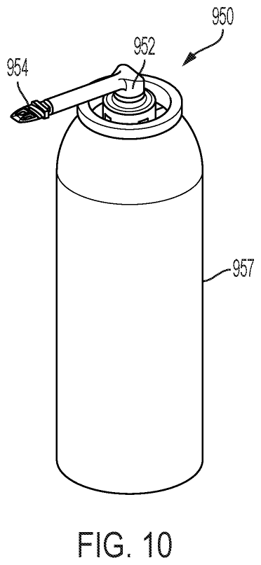

FIG. 10 depict another exemplary injection system 950, with a different exemplary actuator 952 connected to delivery device 957. The actuator depicted in this figure connects the injection tool 954 horizontally.

### Liquid Formulations

Any suitable liquid formulations may be used in the injection systems described herein. In some embodiments, the liquid formulation is water soluble. In some variations, the liquid formulation comprises nutrients. In some variations, the liquid formulation comprises micronutrients. In some variations, the liquid formulation is a semi-liquid formulation. In some variations, the liquid formulation is a gel formulation. In some variations, the liquid formulation is delivered as a semi-liquid or a gel formulation.

In some embodiments, the liquid formulation comprises one or more active ingredients. In some variations, formulations are prepared, e.g., by mixing the active ingredients with one or more suitable additives such as suitable extenders, solvents, spontaneity promoters, carriers, emulsifiers, dispersants, frost protectants, biocides, thickeners, adjuvants or the like. An adjuvant in this context is a component which enhances the biological effect of the formulation, without the component itself having a biological effect. Examples of adjuvants are agents which promote the retention, spreading, or penetration in the target plant. One embodiment of the disclosure comprises a long-term supply of the active ingredient to the plant over the growing season, with an auxiliary being stabilizers, such as low-temperature stabilizers, preservatives, antioxidants, light stabilizers or other agents which improve chemical and/or physical stability.

Examples of typical liquid formulations include water-soluble liquids (SL), emulsifiable concentrates (EC), emulsions in water (EW), suspension concentrates (SC, SE, FS, OD), water-dispersible granules (WG) and fluids (which include one or more of a liquid, gas, gel, vapor, aerosol or the like). These and other possible types of formulation are described, for example, by Crop Life International and in Pesticide Specifications, Manual on development and use of FAO and WHO specifications for pesticides, FAO Plant Production and Protection Papers, prepared by the FAO/WHO Joint Meeting on Pesticide Specifications, 2004, ISBN: 9251048576; “Catalogue of pesticide formulation types and international coding system,” Technical Monograph No. 2, 6th Ed. May 2008, CropLife International.

In some embodiments, compositions are prepared in a known manner, such as described by Mollet and Grubemann, Formulation technology, Wiley VCH, Weinheim, 2001; or Knowles, New developments in crop protection product formulation, Agrow Reports DS243, T&F Informa, London, 2005. Formulations are prepared, e.g., by mixing the active ingredients with one or more suitable additives such as suitable extenders, solvents, spontaneity promoters, carriers, emulsifiers, dispersants, frost protectants, biocides, thickeners, adjuvants or the like. An adjuvant in this context is a component which enhances the biological effect of the formulation, without the component itself having a biological effect. Examples of adjuvants are agents which promote the retention, spreading, or penetration in the target plant. One embodiment of the disclosure comprises a long-term supply of the active ingredient to the plant over the growing season, with an auxiliary being stabilizers, such as low-temperature stabilizers, preservatives, antioxidants, light stabilizers or other agents which improve chemical and/or physical stability.

Examples for suitable auxiliaries are solvents, liquid carriers, surfactants, dispersants, emulsifiers, wetters, adjuvants, solubilizers, penetration enhancers, protective colloids, humectants, repellents, attractants, feeding stimulants, compatibilizers, bactericides, anti-freezing agents, antifoaming agents, colorants, stabilizers or nutrients, UV protectants, tackifiers, and/or binders. Specific examples for each of these auxiliaries are well known to the person of ordinary skill in the art, see, for example, US 2015/0296801 A1.

The compositions can optionally comprise 0.1-80% stabilizers and/or nutrients and 0.1-10% UV protectants. General examples of suitable ratios for multiple formulation types referenced above are given in Agrow Reports DS243, T&F Informa, London, 2005.

At certain application rates, the compositions and/or formulations according to the disclosure may also have a strengthening effect in plants. “Plant-strengthening” (resistance-inducing) substances are to be understood as meaning, in the present context, those substances or combinations of substances which are capable of stimulating the defence system of plants in such a way that, when subsequently inoculated with harmful microorganisms, the treated plants display a substantial degree of resistance to these microorganisms.

In some embodiments, when applying active ingredients, the application can be continuous over a longer period or intervals. In some variations, the application could also be coupled with a disease monitoring system and be triggered “on demand.” In some variations, the formulations can comprise between 0.5% and 90% by weight of active compound, based on the weight of the formulation.

Numerous active ingredients can be used in the injection systems described herein. The active ingredients specified herein by their “common name” are known and described, for example, in The Pesticide Manual (18^{th} edition, Ed. Dr. J A Turner (2018), which includes, among other agents, herbicides, fungicides, insecticides, acaricides, nematocides, plant growth regulators, repellents, synergists).

### Uses

In some embodiments, the present disclosure provides a process for modulating the phenotype of a plant or a multitude of plants by installing a plant injection system according to the disclosure in the plant or multitude of plants and administering a liquid formulation of an active ingredient to modulate the phenotype of the plant. In other embodiments, the present disclosure provides a method to modulate phenotypes of plants, for instance to treat, prevent, protect and immunize, which means induce local and systemic resistance to plants from pathogenic attacks and pest attacks. The injection tools described herein distribute liquid formulations directly to the interior of the plant without spraying and the commensurate loss of errantly applied sprayed formulations. The subject matter described herein places the formulations in direct contact with plant tissues and in some embodiments, the formulations are selectively administered at appropriate times to minimize (e.g., eliminate or minimize) the accumulation of chemical residues in fruits or crops as mandated. For example, the present disclosure includes injection methods, devices and systems for treating plants whose xylem and/or phloem may be subject to invasion by bacteria, fungi, virus and/or other pathogens; and/or for controlling bacteria, fungi, virus and/or other pathogens which invade the xylem and/or phloem of plants.

### Plants

By “plants” is meant all plants and plant populations such as desirable and undesirable wild plants, cultivars and plant varieties (whether or not protectable by plant variety or plant breeder's rights). Cultivars and plant varieties can be plants obtained by conventional propagation and breeding methods which can be assisted or supplemented by one or more biotechnological methods such as by use of double haploids, protoplast fusion, random and directed mutagenesis, molecular or genetic markers or by bioengineering and genetic engineering methods. “Plant” includes whole plants and parts thereof, including, but not limited to, shoot vegetative organs/structures (e.g. leaves, stems and tubers), roots, flowers and floral organs/structures (e.g. bracts, sepals, petals, stamens, carpels, anthers and ovules), seed (including embryo, endosperm, and seed coat) and fruit (the mature ovary), plant tissue (e.g. vascular tissue, ground tissue, and the like) and cells (e.g. guard cells, egg cells, and the like), and progeny of same. “Fruit” and “plant produce” are to be understood as any plant product which is further utilized after harvesting, e.g. fruits in the proper sense, nuts, wood etc., that is anything of economic value that is produced by the plant.

In some variations, plants that can benefit from application of the products and methods of the subject disclosure are selected from Tree Crops (e.g., Walnuts, Almonds, Pecans, Hazelnuts, Pistachios, etc.), citrus trees (Citrus spp. e.g., orange, lemon, grapefruit, mandarins etc.), Fruit Crops (such as pomes, stone fruits or soft fruits, for example apples, pears, plums, peaches, cherries etc.), Vine Crops (e.g., Grapes, Blueberries, Blackberries, etc.), coffee (Coffea spp.), coconut (Cocos iiucifera), pineapple (Ananas comosus), cocoa (Theobroma cacao), tea (Camellia sinensis), banana (Musa spp.), lauraceous plants (such as avocados (Persea americana), cinnamon or camphor), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), natural rubber tree, date tree, oil palm tree, ornamentals, forestry (e.g., pine, spruce, eucalyptus, poplar, conifers etc) and/or box trees.

Conifers that may be employed in practicing the embodiments are selected from pines such as loblolly pine (Pinus taeda), slash pine (Pinus elliotii), ponderosa pine (Pinus ponderosa), lodgepole pine (Pinus contorta), and Monterey pine (Pinus radiata); Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and/or Alaska yellow-cedar (Chamaeeyparis nootkatensis).

Palm trees that may be treated are selected from Archontophoenix alexandrae (king Alexander palm), Arenga spp. (Dwarf sugar palm), Borassus flabellifer (Lontar palm), Brahea armata (blue hesper palm), Brahea edulis (Guadalupe palm), Butia capitate (pindo palm), Chamaerops humilis (European fan palm), Carpentaria spp (Carpenteria palm), Chamaedorea elegans (parlor palm), C. erupens (bamboo palm), C. seifrizii (reed palm), Chrysalidocarpus lutescens (areca palm), Coccothrinax argentata (silver palm), C. crinite (old man palm), Cocos nucifera (coconut palm), Elaeis guineensis (African oil palm), Howea forsterana (kentia palm), Livistona rotundifolia (round leaf fan palm), Neodypsis decaryi (triangle palm); Normanbya normanbi (Queensland black); Pinanga insignis; Phoenix canariensis (Canary Island date); Ptychosperma macarthuri (Macarthur palm); Rhopalostylis spp (shaving brush p.); Roystonea elata (Florida royal palm), R. regia Cuban (royal palm), Sabal spp (Cabbage/palmetto), Syagrus romanzoffiana (queen palm), Trachycarpus fortune (windmill palm), Trythrinax acanthocoma (spiny fiber palm), Washingtonia filifera (petticoat palm) and/or W. robusta (Washington/Mexican fan palm). One embodiment includes the prevention or cure of bud rot of palm trees caused, for example, by Phytophthora palmivora, Thielaviopsis paradoxa and/or bacteria. Unlike most trees, which have many points where new growth emerges, palms rely on their single terminal bud. If the terminal bud or heart becomes diseased and dies, the tree will not be able to put out any new leaf growth and will die. That is why preventative care is needed to maintain a healthy palm tree.

### Diseases

One embodiment comprises a method for reducing damage of plants and/or plant parts or losses in harvested fruits or plant produce caused by phytopathogenic fungi by controlling such phytopathogenic fungi, comprising applying the tools, system, agents/formulations or methods of the disclosure to the plant. In some variations, the injection systems described herein may be used for controlling, preventing, or curing the following fungal plant diseases selected from the group: Botrytis cinerea (teleomorph: Botryotinia fuckeliana: grey mold) on fruits and berries (e.g. strawberries), rape, vines, forestry plants; Ceratocystis (syn. Ophiostoma) spp. (rot or wilt) on broad-leaved trees and evergreens, e.g. C. ulmi (Dutch elm disease) on elms; Cercospora spp. (Cercospora leaf spots) on coffee,; Colletotrichum (teleomorph: Glomerella) spp. (anthracnose) on soft fruits; Cycloconium spp., e.g. C. oleaginum on olive trees; Cylindrocarpon spp. (e.g. fruit tree canker or young vine decline, teleomorph: Nectria or Neonectria spp.) on fruit trees, vines (e.g. C. liriodendri, teleomorph: Neonectria liriodendri: Black Foot Disease) and ornamentals; Esca (dieback, apoplexy) on vines, caused by Formitiporia (syn. Phellinus) punctata, F.mediterranea, Phaeomoniella chlamydospora (earlier Phaeoacremonium chlamydosporum), Phaeoacremonium aleophilum and/or Botryosphaeria obtuse; Elsinoe spp. on pome fruits (E. pyn), soft fruits (E. veneta: anthracnose) and vines (E. ampelina: anthracnose); Eutypa lata (Eutypa canker or dieback, anamorph: Cytosporina lata, syn. Libertella blepharis) on fruit trees, vines and ornamental woods; Fusarium (teleomorph: Gibberella) spp. (wilt, root or stem rot) on various plants; Glomerella cingulata on vines, pome fruits and other plants; Guignardia bidwellii (black rot) on vines; Gymnosporangium spp. on rosaceous plants and junipers, e.g. G. sabinae (rust) on pears; Hemileia spp., e.g. H. vastatrix (coffee leaf rust) on coffee; Isariopsis clavispora (syn. Cladosporium vitis) on vines; Monilinia spp., e.g. M. taxa, M. fructicola and M. fructigena (bloom and twig blight, brown rot) on stone fruits and other rosaceous plants; Mycosphaerella spp. on bananas, soft fruits, such as e.g. M. fijiensis (black Sigatoka disease) on bananas; Phialophora spp. e.g. on vines (e.g. P. tracheiphila and P. tetraspora); Phomopsis spp. on vines (e.g. P. viticola: can and leaf spot); Phytophthora spp. (wilt, root, leaf, fruit and stem root) on various plants, such as broad-leaved trees (e.g. P. ramorum: sudden oak death); Plasmopara spp., e.g. P. viticola (grapevine downy mildew) on vines; Podosphaera spp. (powdery mildew) on rosaceous plants, hop, pome and soft fruits, e.g. P. leucotricha on apples; Pseudopezicula tracheiphila (red fire disease or rotbrenner', anamorph: Phialophora) on vines; Ramularia spp., e.g. R. collo-cygni (Ramularia leaf spots, Physiological leaf spots) on barley and R. beticola on sugar beets; Rhizoctonia spp. on cotton, rice, potatoes, turf, corn, rape, potatoes, sugar beets, vegetables and various other plants, e.g. R. solani (root and stem rot) on soybeans, R. solani (sheath blight) on rice or R. cerealis(Rhizoctonia spring blight) on wheat or barley; Rhizopus stolonifer (black mold, soft rot) on vines; Uncinula (syn. Erysiphe) necator (powdery mildew, anamorph: Oidium tuckeri) on vines; Taphrina spp., e.g. T. deformans (leaf curl disease) on peaches and T. pruni (plum pocket) on plums; Thielaviopsis spp. (black root rot) on pome fruits; Venturia spp. (scab) on apples (e.g. V. inaequalis) and pears; and/or Verticillium spp. (wilt) on various plants, such as fruits and ornamentals, vines, soft fruits.

In some variations, the injection systems herein may be employed for controlling, preventing, or curing the diseases in plants selected from:
Diseases of apple: blossom blight (Monilinia mali), powdery mildew (Podosphaera leucotricha), Alternaria leaf spot/Alternaria blotch (Alteraaria alternata apple pathotype), scab (Venturia inaequalis), bitter rot (Colletotrichum acutatum), anthrax (Colletotrieiium acutatum), decomposed disease (Valsa ceratosperma), and/or crown rot (Phytophtora cactorum);
Diseases of pear: scab (Venturia nashicola, V. pirina), black spot/purple blotch (Alternaria alternate Japanese pear pathotype). rust/frogeye (Gymnosporangium haraeanum), and/or phytophthora fruit rot (Phytophtora cactorum);
Diseases of peach: brown rot (Monilinia fructicola), black spot disease/scab (Cladosporium carpophilum), and/or phomopsis rot (Phomopsis sp.);
Diseases of grape: anthracnose (Elsinoe ampelina), powdery mildew (Uncinula necator), ripe rot (Glomerella cingulata), black rot (Guignardia bidwelli i), downy mildew (Plasmopara viticola), rust (Phakopsora ampelopsidis), and/or gray mold (Botrytis cinerea);
Diseases of Japanese persimmon: anthracnose (Gloeosporium kaki) and/or leaf spot (Cercospora kaki, Mycosphaerella nawae);
Diseases of cruciferous vegetables: Alternaria leaf spot (Alternaria japonica), white spot (Cercosporella brassicae), and/or downy mildew (Peronospora parasitica); Diseases of rapeseed: sclerotinia rot (Sclerotinia sclerotiorum) and/or gray leaf spot (Alternaria brassicae);
Diseases of rose: black spot (Diplocarpon rosae) and/or powdery mildew (Sphaerotheca pannosa);
Disease of banana: sigatoka (Mycosphaerella fijiensis, Mycosphaerella musicola, Pseudocercospora musae); and/or Colletotrichum musae, Armillaria mellea, Armillaria tabescens, Pseudomonas solanacearum, Phyllachora musicola, Mycosphaerella fijiensis, Rosellinia bunodes, Pseudomas spp., Pestalotiopsis leprogena, Cercospora hayi, Pseudomonas solanacearum, Ceratocystis paradoxa, Verticillium theobromae, Trachysphaera fructigena, Cladosporium musae, Junghuhnia vincta, Cordana johnstonii, Cordana musae, Fusarium pallidoroseum, Colletotrichum musae, Verticillium theobromae, Fusarium spp Acremonium spp., Cylindrocladium spp., Deightoniella torulosa, Nattrassia mangiferae, Dreschslera gigantean, Guignardia musae, Botryosphaeria ribis, Fusarium solani, Nectria haematococca, Fusarium oxysporum, Rhizoctonia spp., Colletotrichum musae, Uredo musae, Uromyces musae, Acrodontium simplex, Curvularia eragrostidis, Drechslera musae-sapientum, Leptosphaeria musarum, Pestalotiopsis disseminate, Ceratocystis paradoxa, Haplobasidion musae, Marasmiellus inoderma, Pseudomonas solanacearum, Radopholus similis, Lasiodiplodia theobromae, Fusarium pallidoroseum, Verticillium theobromae, Pestalotiopsis palmarum, Phaeoseptoria musae, Pyricularia grisea, Fusarium moniliforme, Gibberella fujikuroi, Erwinia carotovora, Erwinia chrysanthemi, Cylindrocarpon musae, Meloidogyne arenaria, Meloidogyne incognita, Meloidogyne javanica, Pratylenchus coffeae, Pratylenchus goodeyi, Pratylenchus brachyurus, Pratylenchus reniformia, Sclerotinia sclerotiorum, Nectria foliicola, Mycosphaerella musicola, Pseudocercosporamusae, Limacinula tenuis, Mycosphaerella musae, Helicotylenchus multicinctus, Helicotylenchus dihystera, Nigrospora sphaerica, Trachysphaera frutigena, Ramichloridium musae, Verticillium theobromae;
Disease of citrus fruits: black spot disease (Diaporthe citri), scab (Elsinoe fawcetti), and/or fruit rot (Penicillium digitatum, P. italicum);
Disease of tea: net rice disease (Exobasidium reticulatum), disease victory (Elsinoe leucospila), ring leaf spot (Pestalotiopsis sp.), anthracnose (Colletotrichum theaesinensis;
Disease of plam trees: Bud Rot, Crown Rot, Red Ring, Pudricion de Cogollo, Lethal Yellowing;
Diseases of box tree: boxwood blight fungus (Cylindrocladium buxicola also called Calonectria pseudonaviculata), Volutella buxi, Fusarium buxicola.

The methods of the disclosure can be used to reduce damage caused by a wide range of insect pests. Target insects can be selected from the order of Lepidoptera, Coleoptera, Diptera, Thysanoptera, Hymenoptera, Orthoptera, Acarina, Siphonaptera, Thysanura, Chilopoda, Dermaptera, Phthiraptera, Hemipteras, Homoptera, Isoptera and/or Aptero. Examples of such pests include, but are not limited to, Arthropods, including, for example, Lepidoptera (for example, Plutellidae, Noctuidae, Pyralidae, Tortricidae, Lyonetiidae, Carposinidae, Gelechiidae, Crambidae, Arctiidae, and/or Lymantriidae), Hemiptera (for example, Cicadellidae, Delphacidae, Psyllidae, Aphididae, Aleyrodidas, Orthezidae, Miridae, Tingidae, Pentatomidae, and/or Lygaiedae), Coleoptera (for example, Scarabaeidae, Elateridae, Coccinellidae, Cerambycidae, Chrysomelidae, and/or Curculionidae), Diptera (for example, Muscidae, Calliphoridae, Sarcophagidae, Anthomyiidae, Tephritidae, Opomyzoidea, and/or Carnoidea), Orthoptera (for example, Acrididae, Catantopidae, and Pyrgomorphidae), Thysanoptera (for example, Thripidae, Aeolothripidae, and Merothripidae), Tylenchida (for example, Aphelenchoididae and/or Neotylechidae), Collembola (for example, Onychiurus and lsotomidae), Acarina (for example, Tetranychidae, Dermanyssidae, Acaridae, and/or Sarcoptidae), Stylommatophora (for example, Philomycidae and/or Bradybaenidae), Ascaridida (for example, Ascaridida and/or Anisakidae), Opisthorchiida, Strigeidida, Blattodea (for example, Blaberidae, Cryptocercidae, and/or Panesthiidae), Thysanura (for example, Lepismatidae, Lepidotrichidae, and/or Nicoletiidae) and/or box tree moth/box tree caterpillar (Cydalima perspectalis).

The injection systems described herein may also be useful against bacterial pathogens that attack, consume (in whole or in part), or impede the growth and/or development of plants and/or act as transmission vectors to the plant and/or other plants caused by such bacterial pathogens. The bacterial pathogens can include Agrobacterium, Agrobacterium tumefaciens, Erwinia, Erwinia amylovora, Xanthomonas, Xanthomonas campestris, Pseudomonas, Pseudomonas syringae, Ralstonia solanacearum, Corynebacterium, Streptomyces, Streptomyces scabies, Actinobacteria, Micoplasmas, Spiroplasmas and/or Fitoplasmas.

The injection systems described herein may also be useful for mitigating, controlling and/or eradicating viral pathogens that attack, consume (in whole or in part), or impede the growth and/or development of the plant and/or act as transmission vectors to the plant and/or other plants caused by such viral pathogens. Such viral pathogens can include Carlaviridae, Closteroviridae, viruses that attack citrus fruits, Cucumoviridae, Ilarviridae, dwarf virus attacking prunes, Luteoviridae, Nepoviridae, Potexviridae, Potyviridae, Tobamoviridae, Caulimoviridae,as well as other viruses that attack vegetation and crops.

Plant growth-regulating compounds can be used, for example, to inhibit the vegetative growth of the plants. Such inhibition of growth is of economic interest, for example, the inhibition of the growth of herbaceous and woody plants on roadsides and in the vicinity of pipelines or overhead cables, or quite generally in areas where vigorous plant growth is unwanted. Inhibition of the vegetative plant growth may also lead to enhanced yields because the nutrients and assimilates are of more benefit to flower and fruit formation than to the vegetative parts of the plants. Frequently, growth regulators can also be used to promote vegetative growth. This is of great benefit when harvesting the vegetative plant parts. However, promoting vegetative growth may also promote generative growth in that more assimilates are formed, resulting in more or larger fruits.

Use of growth regulators can control the branching of the plants. On the one hand, by breaking apical dominance, it is possible to promote the development of side shoots, which may be highly desirable particularly in the cultivation of ornamental plants, also in combination with an inhibition of growth. On the other hand, however, it is also possible to inhibit the growth of the side shoots. This effect is of particular interest, for example, in the cultivation of tobacco or in the cultivation of tomatoes. Under the influence of growth regulators, the amount of leaves on the plants can be controlled such that defoliation of the plants is achieved at a desired time. Such defoliation plays a major role in the mechanical harvesting of cotton, but is also of interest for facilitating harvesting in other crops, for example in viticulture.

Growth regulators can also be used to achieve faster or delayed ripening of the harvested material before or after harvest. This is particularly advantageous as it allows optimal adjustment to the requirements of the market. Moreover, growth regulators in some cases can improve fruit color. In addition, growth regulators can also be used to concentrate maturation within a certain period of time. This establishes the prerequisites for complete mechanical or manual harvesting in a single operation, for example in coffee.

By using growth regulators, it is additionally possible to influence the resting of seed or buds of the plants, such that plants, including pineapple or ornamental plants in nurseries, for example, germinate, sprout or flower at a time when they are normally not inclined to do so.

Further, growth regulators can induce resistance of the plants to frost, drought or high salinity of the soil. This allows the cultivation of plants in regions which are normally unsuitable.

The compositions and/or formulations according to the disclosure also exhibit a potent strengthening effect in plants. Accordingly, they can be used for mobilizing the defences of the plant against attack by undesirable microorganisms. Plant-strengthening (resistance-inducing) substances are to be understood as meaning, in the present context, those substances which are capable of stimulating the defence system of plants in such a way that the treated plants, when subsequently inoculated with undesirable microorganisms, develop a high degree of resistance to these microorganisms. The active compounds according to the disclosure are also suitable for increasing the yield of crops. In addition, they show reduced toxicity and are well tolerated by plants.

Further, in context with the present disclosure plant physiology effects comprise the following (all of which can be modulated by the compositions, methods and devices provided herein): abiotic stress tolerance, comprising temperature tolerance, drought tolerance and recovery after drought stress, water use efficiency (correlating to reduced water consumption), flood tolerance, ozone stress and UV tolerance, tolerance towards chemicals like heavy metals, salts, pesticides (safener) etc.; and biotic stress tolerance, comprising increased resistance fungal diseases, increased resistance against nematodes, viruses and bacteria; and increased plant vigor, comprising plant health, plant quality, seed vigor, reduced stand failure, improved appearance, increased recovery, improved greening effect and improved photosynthetic efficiency.

In addition, the injection systems described herein may be employed to reduce the mycotoxin content in the harvested material and the foods and feeds prepared therefrom.

In another embodiment of the disclosure the injection systems described herein may be employed to provide to the plant nutritional elements like nitrogen, phosphorous and potassium, as well as mineral elements, including but not limited to, silicium, calcium, magnesium and manganese.

In some embodiments, provided is a method for treating a plant whose xylem or phloem or both are invaded by, or are at risk of being invaded by, bacteria, fungi, virus and/or other pathogens, using the injection systems described herein. In some embodiments, the method improves the strength of the plant to withstand attack of bacteria. In some variations, the method strengthens an infected plant or improves plant health recovery of the infected plant.

In some embodiments, the disclosure provides methods for improving the strength of a plant infected by Xylella fastidiosa, which is a xylem-limited plant bacteria thought to cause the referenced disease. In certain embodiments, the disclosure provides methods for enhancing or maintaining the health of olive trees. In some embodiments, the disclosure provides methods for treating olive quick declines syndrome in olive trees. In some variations, the disclosure provides methods for improving the strength of an olive tree infected by Xylella fastidiosa subsp. pauca. In other variations, the disclosure provides methods for improving the strength of an olive tree infected by Xylella fastidiosa subsp. multiplex.

In other embodiments, the disclosure provides methods for improving the strength of an olive tree infected by Xylella fastidiosa subsp. fastidiosa, Xylella fastidiosa subsp. multiplex, Xylella fastidiosa subsp. sandyi, and/or Xylella fastidiosa subsp. pauca. For example, in some variations, provided are methods for improving the strength of grapevines infected by Xylella fastidiosa subsp. fastidiosa. In some variations, provided are methods for improving the strength of a citrus tree infected by Xylella fastidiosa subsp. pauca. In some variations, provided are methods for improving the strength of stone fruit trees infected by Xylella fastidiosa subsp. multiplex. In one variation, provided are methods for improving the strength of cherry, plum, peach and/or almond trees infected by Xylella fastidiosa subsp. multiplex.

In some embodiments, this disclosure provides methods for enhancing or maintaining plant health in the citrus plants and grove. In some such embodiments, this disclosure provides methods for treating diseased plants and/or methods for controlling the bacteria, fungi, viruses and/or other pathogens that cause citrus greening disease in the citrus plants. In further such embodiments, this disclosure provides methods for treating citrus plants whose xylem and/or phloem have been invaded by disease-causing bacteria, fungi, viruses, and/or other pathogens, for controlling the bacteria, fungi, virus and/or other pathogens causing the disease, and for preventing diseases by preventing sufficient colonization of the plant by the disease causing pathogens such as bacteria, fungi, and viruses.

In some embodiments, controlling citrus greening disease in citrus plants using the systems, devices and methods herein includes reducing the bacterial concentration (titer) in the vascular system. In some variations, controlling citrus greening disease in citrus plants using the systems, devices and methods herein includes reducing the bacterial concentration (titer) in the vascular system by strengthening the plant's natural defense system. In certain embodiments, the systems, devices and methods herein can provide a treatment that leads to suppression of the disease to a level where recovery of citrus production occurs. In some variations, bacterial titer refers to the bacterial concentration in the vascular system of the infected plant. Bacterial titer may be measured using any suitable methods and techniques known in the art. For example, in one variation, bacterial titer is measured through quantitative PCR. In one variation, CLas titer is measured, e.g., using any suitable techniques known in the art.

In some embodiments, the citrus plant is a citrus tree or a citrus bush. In some variations, the citrus tree is an orange tree, a lemon tree, a lime tree, a grapefruit tree, or a pomelo tree. In certain variations, the citrus plant is a lemon bush, or a lime bush. In one variation, the citrus bush is a dwarf citrus bush. In other variations, the citrus tree is a mature tree.

In some variations, the citrus plants are suffering from citrus greening disease caused by Liberibacter spp. (e.g., L. asiaticus, L. africanus, L. americanus). In some variations, the disease is transmitted by the Asian citrus psyllid, Diaphorina citri, and the African citrus psyllid, Trioza erytreae.

In some embodiments, the infected citrus plant exhibits at least one symptom caused by citrus greening disease. In some embodiments, the citrus plant to which the injection formulation is applied is infected. In some embodiments, the citrus plant to which the injection formulation is applied is not infected. In some embodiments, the methods described herein are used only for citrus plants with one or more symptoms caused by citrus greening disease. Such symptoms may include any one or more of the following: asymmetrical yellowing of veins and adjacent tissues; splotchy mottling of the entire leaf; premature defoliation; dieback of twigs; decay of feeder rootlets and lateral roots; decline in vigor; stunted growth, bear multiple off-season flowers; produce small, irregularly shaped fruit with a thick, pale peel that remains green at the bottom and tastes bitter.

### EXAMPLES

The presently disclosed subject matter will be better understood by reference to the following examples, which are provided as exemplary of the invention, and not by way of limitation.

### Example 1

### Finite Element Analysis

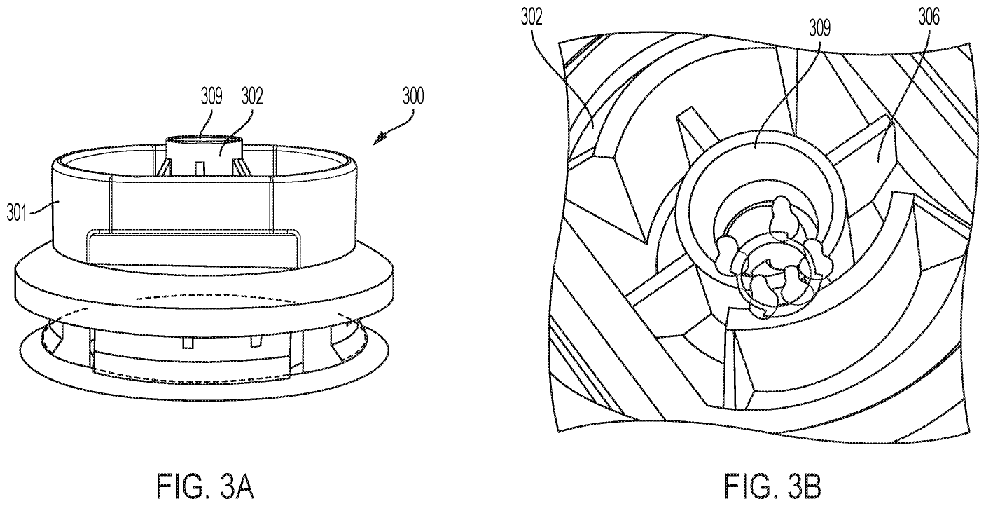

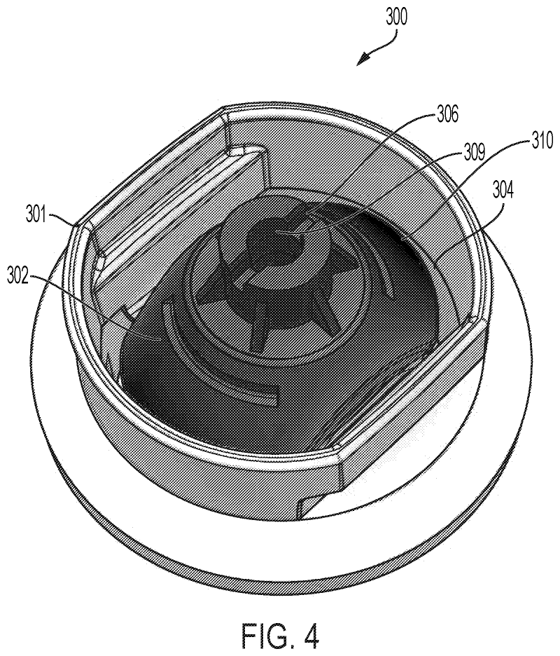

This example tests the actual deformation called displacement and stress of the exemplary actuator using a finite element analysis. The actuator used in this example is depicted in FIGS. 3A, 3B, and 4 as actuator 300. Actuator 300 comprises activator 302 and frame 301. The activator is configured to mount the injection tool, which is equipped with positioning slots 306 on female port 309 to ensure a precise connection between the activator and the injection tool. The actuator's load case included four fixed constraints at the spreaders 304, and a load was applied to the top where the stem of the pressurized spraycan sits, with reference to FIG. 3B. The load is a linear force of 30 N, which is the maximal force that the stem of the spraycan used can reach. The exemplary actuator used in this example was injection molded out of polypropylene. Because of the predetermined breaking points that disconnect the activator from the frame in case of a pulling force of the spraycan, the wall thickness of these breaking points were relatively thin, and led to an acceptable maximal displacement of about 0.19 mm around region 310 as depicted in FIG. 4. The actuator demonstrated acceptable ranges when tested for various factors, including stress, displacement, reaction force, and strain.

What is claimed is:

1. An actuator for connecting an injection tool and a fluid delivery device, wherein the fluid delivery device comprises a canister that holds a liquid formulation, wherein the top of the canister has a lip, and wherein the fluid delivery device further comprises a stem connected to the canister; wherein the actuator comprises:
an activator, wherein the activator is configured to trigger or activate the stem of the fluid delivery device by pressing on it, and wherein the activator is configured to mount the injection tool; and
a frame, wherein the frame comprises one or more spreaders that press on the lip of the fluid delivery device and pulls itself against the lip, wherein the frame has one or more predetermined breaking points configured to break when the activator is pushed down.

2. The actuator of claim 1, wherein the activator has a positioning slot configured to receive the injection tool so as to facilitate a precise connection between the actuator and the injection tool.

3. The actuator of claim 1, wherein the frame comprises at least one second locking mechanism, and the at least one first and at least one second locking mechanisms interface after the activator is pushed down to maintain the activator is a pressed down position.

4. The actuator of claim 1 , wherein the activator is injection molded as one part.

5-17. (canceled)

18. A plant injection system, comprising:
the actuator according to claim 1;
an injection tool configured to deliver a liquid formulation into a plant, the injection tool comprising an injection tip connected to a socket; and
a fluid delivery device;
wherein the socket of the injection tool is configured to insert into the actuator so that the injection tool is in fluid connection with the fluid delivery device by connection through the actuator.

19. The plant injection system of claim 18, wherein the injection tool is configured to insert vertically, relative to the fluid delivery device, into the actuator.

20. The plant injection system of claim 18, wherein the injection tool is configured to insert horizontally, relative to the fluid delivery device, into the actuator.

21. The plant injection system of claim 18, wherein the fluid delivery device comprises a pressurized canister.

22. The plant injection system of claim 18 18 to 21, wherein the fluid delivery device comprises a canister with a bag-on-valve insert.

23. (canceled)

24. The plant injection system of claim 18, wherein the liquid formulation comprises one or more active ingredients.

25. The plant injection system of claim 18, wherein the injection tool releases the liquid formulation into the active vasculature of the plant part.

26. A method for positioning and mounting a plant injection system onto a plant part, the method comprising:
installing an injection tool of the plant injection system into a trunk or stem of the plant part;
setting the injection tool by pressing on a top beam; and
pushing a fluid delivery device, which is in fluid connection with the injection tool, so that predetermined breaking points of an actuator of the plant injection system bridges allowing the activator to snap into a frame of the actuator.

27. The method of claim 26, further comprising distributing liquid formulation through the injection tool to the plant part.

28. The method of claim 27, wherein installing the injection tool into the trunk or stem of the plant part comprises:
piercing the trunk or stem of the plant part with a cutting edge, wherein the injection tip is moved along a longitudinal body axis of the injection tool.

29. The method of claim 27, wherein distributing the liquid formulation to the plant part comprises:
transmitting the liquid formulation from an inlet port of the injection tool to orifices of an injection tip of the injection tool; and
delivering the liquid formulation from the orifices to distribution reservoirs of the injection tool.

30. The method of claim 27, further comprising:
retaining the liquid formulation along a plant tissue of the plant part.

31. The method of claim 27, wherein the liquid formulation is distributed over one or more hours; or wherein the liquid formulation is continuously distributed.

32. (canceled)

33. A method of modulating the phenotype of a plant or a multitude of plants, or treating a plant infected with a pathogen, or mitigating, controlling and/or eradicating a pathogen in a plant, or improving abiotic or biotic stress tolerance in a plant, wherein the method comprises:
installing a plant injection system in the plant or multitude of plants, wherein the plant injection system includes:
an actuator;
an injection tool comprising an injection tip connected to a socket; and
a fluid delivery device;
wherein the socket of the injection tool is configured to insert into the actuator so that the injection tool is in fluid connection with the fluid delivery device by connection through the actuator; and
applying, via the injection tool, a liquid formulation of an active ingredient from the fluid delivery device to modulate the phenotype of the plant, or treat a plant infected with a pathogen, or mitigate, control and/or eradicate a pathogen in a plant, or improve abiotic or biotic stress tolerance in a plant.

34. The method of claim 33, wherein the pathogen is a viral pathogen, bacterial pathogen, fungus, nematode, or insect pest; and/or
wherein the plant is a tree crop; or a citrus tree; or a fruit crop; or a vine crop; or a coffee, coconut, pineapple, cocoa, tea, banana, lauraceous plants, fig, guava, mango, olive, papaya, cashew, macadamia, almond, natural rubber tree, date tree, oil palm tree, ornamentals, forestry, or box trees.

35. The method of claim 33, wherein the liquid formulation is delivered into the vascular system of the plant.

36. (canceled)
